(19) United States
(12) Patent Application Publication
(10) Pub. No.: US 2024/0267087 A1
(43) Pub. Date: Aug. 8, 2024

(54) DEVICES AND METHODS FOR SIGNALING FOR COORDINATED BEAMFORMING

(71) Applicant: HUAWEI TECHNOLOGIES CO., LTD., Shenzhen (CN)

(72) Inventors: Oded REDLICH, Hod Hasharon (IL); Shimon SHILO, Hod Hasharon (IL); Genadiy TSODIK, Hod Hasharon (IL); Doron EZRI, Hod Hasharon (IL); Arik KLEIN, Hod Hasharon (IL); Jian YU, Shenzhen (CN)

(21) Appl. No.: 18/638,573

(22) Filed: Apr. 17, 2024

Related U.S. Application Data
(63) Continuation of application No. PCT/CN2021/124516, filed on Oct. 18, 2021.

(51) Int. Cl. H04B 7/024

(52) U.S. Cl. CPC H04B 7/024

(57) ABSTRACT

An access point, AP, is provided, configured to perform coordinated beamforming with at least one further AP. The AP is configured to communicate via one or more first spatial streams of a plurality of spatial streams with one or more first non-AP stations and the further AP is configured to communicate via one or more second spatial streams of the plurality of spatial streams with one or more second non-AP stations. The AP comprises a processing circuitry configured to obtain information indicative of a total number of the plurality of spatial streams. The AP further comprises a communication interface configured to transmit a frame to each of the one or more first non-AP stations, wherein the frame comprises management information including the information indicative of the total number of the plurality of spatial streams.

### CROSS-REFERENCE TO RELATED APPLICATIONS

This application is a continuation of International Application No. PCT/CN2021/124516, filed on Oct. 18, 2021, the disclosure of which is hereby incorporated by reference in its entirety.

### TECHNICAL FIELD

The present disclosure relates to wireless communications. More specifically, the present disclosure relates to devices and methods for signaling for coordinated beamforming.

### BACKGROUND

IEEE-802.11-based WLANs have become popular at an unprecedented rate. WLANs support a variety of data transfer modes including (but not only) file transfer, emails, web browsing and real-time applications such as audio and video applications. For efficiently supporting high throughputs, the evolving IEEE 802.11 standards specify several transmission (TX) schemes. Particularly useful for increasing the link throughput are TX schemes which deploy multiple TX antennas (some, but not all, also requiring multiple RX antennas on the receiver side), which are so called MIMO modes. Multiple TX antennas can be utilized in different advantageous ways, such as spatial TX diversity for improving the link reliability and performance, beamforming (BF), i.e. focusing the radiated power in the direction(s) of target receiver(s) and/or suppressing it in undesirable directions, for reducing unwanted interference to non-targeted receivers, and/or spatial multiplexing (SM), i.e. sending multiple data streams simultaneously over the same time-frequency resources, either to the same receiver or to different ones. Coordinated beamforming (also referred to as C-BF or CoBF) is a cooperation scheme where multiple access points (APs) cooperate such that when an AP transmits to its associated stations (STAs), i.e. to the STAs of its basic service set (BSS) it creates a null towards the STAs of an overlapping BSS (OBSS). In this way, the OBSS STAs are not interfered by the AP's transmission.

The 802.11be standard is planned to support multi-AP schemes, in which multiple APs collaborate to transmit at the same time. Release 1 of 802.11be does not support CoBF because it lacks signaling for this purpose.

### SUMMARY

It is an objective of the present disclosure to provide improved devices and methods for signaling for coordinated beamforming (CoBF).

The foregoing and other objectives are achieved by the subject matter of the independent claims. Further implementation forms are apparent from the dependent claims, the description and the figures.

According to a first aspect, an access point, AP, is provided, which is configured to perform coordinated beamforming with at least one further AP of a coordinated beamforming set. The AP is further configured to communicate via one or more first spatial streams of a plurality of spatial streams with one or more first non-AP stations and the at least one further, i.e. second AP is configured to communicate via one or more second spatial streams of the plurality of spatial streams with one or more second non-AP stations. The AP comprises a processing circuitry configured to obtain spatial stream related information indicative of a total number of the plurality of spatial streams in the coordinated beamforming set.

The AP further comprises a communication interface configured to transmit a frame to each of the one or more first non-AP stations associated with the AP, wherein the frame comprises management information including the information indicative explicitly or implicitly of the total number of the plurality of spatial streams in the coordinated beamforming set. The frame may be a data frame and the information may be provided in the preamble of the data frame. Thus, MU-MIMO signaling may be expanded to support CoBF with minimum changes and/or modifications. Therefore, the AP may be efficiently adapted for CoBF by signalling new parameters in order to perform CoBF. Moreover, existing standards for wireless communication can be cost and time efficiently modified to support operating with the AP.

In a further possible implementation form of the first aspect, for each of the one or more first non-AP stations the management information further comprises information indicative of a number of spatial streams of the one or more first spatial streams assigned to the respective first non-AP station.

In a further possible implementation form of the first aspect, for each of the one or more first non-AP stations the management information further comprises information indicative of one or more index values of one or more spatial streams of a subset of the one or more first spatial streams. The subset of the one or more first spatial streams is assigned to the respective first non-AP station.

In a further possible implementation form of the first aspect, the processing circuitry is further configured to assign a respective subset of the one or more first spatial streams to the respective first non-AP station and/or one or more index values to the respective subset of the one or more first spatial streams of the respective first non-AP station.

In a further possible implementation form of the first aspect, the information indicative of the total number of the plurality of spatial streams in the coordinated beamforming set comprises the total number of the plurality of spatial streams in the coordinated beamforming set.

In a further possible implementation form of the first aspect, the frame further comprises a BSS-specific offset value (referred to herein as SS_index_offset) indicative of a smallest index value assigned to the one or more first spatial streams, i.e. assigned to the one or more spatial streams assigned to the one or more non-AP stations of the AP in the BSS.

In a further possible implementation form of the first aspect, the frame comprises a user field for each of the one or more first stations and wherein each user field comprises at least a portion of the management information.

In a further possible implementation form of the first aspect, the plurality of bits comprises at least one or more of the following bits: 11 bits encoding an identifier STA-ID of the respective first non-AP station, 4 bits encoding a modulation and coding scheme MCS, 4 bits encoding a total number NSS of the one or more first non-AP stations, 1 bit encoding a beamforming mode Beamforming, 1 bit encoding a coding scheme Coding, 4 bits encoding an BSS-specific offset value SS_index_offset indicative of a smallest index value assigned to one of the first spatial streams, i.e. the spatial streams assigned to the one or more non-AP stations of the AP in the BSS, and 3 or 4 bits indicative of the total number of the plurality of spatial streams in the coordinated beamforming set.

In a further possible implementation form of the first aspect, the plurality of bits comprises at least one or more of the following bits: 11 bits encoding an identifier STA-ID of the respective first non-AP station, 4 bits encoding a modulation and coding scheme MCS, 1 bit encoding a coding scheme Coding, 6 bits encoding a spatial configuration, 4 bits encoding an BSS-specific offset value SS_index_offset indicative of a smallest index value assigned to the one of the first spatial streams, i.e. the spatial streams assigned to the one or more non-AP stations of the AP in the BSS, and 3 or 4 bits explicitly or implicitly indicative of the total number of the plurality of spatial streams in the coordinated beamforming set.

In a further possible implementation form of the first aspect, the 4 bits encoding the BSS-specific offset value SS_index_offset and the 3 or 4 bits explicitly or implicitly indicative of the total number of the plurality of spatial streams in the coordinated beamforming set are the 7 or 8 most or least significant bits of the plurality of bits of the user field.

In a further possible implementation form of the first aspect, the frame comprises one or more EHT SIG common fields and wherein each EHT SIG common field comprises at least a portion of the management information.

In a further possible implementation form of the first aspect, each EHT SIG common field comprises a plurality of bits, wherein the plurality of bits comprises at least one or more of the following bits: 4 bits encoding an BSS-specific offset value SS_index_offset indicative of a smallest index value assigned to the one or more first spatial streams, i.e. the spatial streams assigned to the one or more non-AP stations of the AP in the BSS, 2 bits encoding a guard interval GI and EHT training field EHT-LTF size, 3 bits encoding a number of EHT training field EHT-LTF symbols, 1 bit encoding a LDPC extra symbol segment, 2 bits encoding a pre-FEC padding factor, 1 bit encoding a PE disambiguity, 3 bits encoding a number of non-OFDMA user and/or 3 or 4 bits explicitly or implicitly indicative of the total number of the plurality of spatial streams in the coordinated beamforming set.

In a further possible implementation form of the first aspect, the 4 bits encoding the BSS-specific offset value SS_index_offset are the 4 most or least significant bits of the EHT SIG common field and wherein the 3 or 4 bits explicitly or implicitly indicative of the total number of the plurality of spatial streams in the coordinated beamforming set are the 3 or 4 least or most significant bits of the EHT SIG common field.

In a further possible implementation form of the first aspect, each EHT SIG common field comprises a plurality of bits, wherein the plurality of bits comprises at least one or more of the following bits: 4 bits encoding a Spatial Reuse configuration, 2 bits encoding a guard interval GI and EHT training field EHT-LTF size, 3 bits encoding a number of EHT training field EHT-LTF symbols, 1 bit encoding a LDPC extra symbol segment, 2 bits encoding a pre-FEC padding factor, 1 bit encoding a PE disambiguity, 3 bits encoding a number of non-OFDMA user, 4 bits encoding an BSS-specific offset value SS_index_offset indicative of a smallest index value assigned to the one or more first spatial streams, i.e. the spatial streams assigned to the one or more non-AP stations of the AP in the BSS and/or 3 or 4 bits explicitly or implicitly indicative of the total number of the plurality of spatial streams in the coordinated beamforming set.

In a further possible implementation form of the first aspect, the 4 bits encoding the BSS-specific offset value SS_index_offset and the 3 or 4 bits explicitly or implicitly indicative of the total number of the plurality of spatial streams in the coordinated beamforming set are the 7 or 8 most or least significant bits of the plurality of bits of the EHT SIG common field.

In a further possible implementation form of the first aspect, the frame comprises a U-SIG field and wherein the U-SIG field comprises at least a portion of the management information.

In a further possible implementation form of the first aspect, the U-SIG field comprises a plurality of bits defining a U-SIG-1 portion and a U-SIG-2 portion and wherein at least the portion of the management information is encoded in bits 20-24 and/or bit 25 of the U-SIG-1 portion and/or in bit 2 and/or bit 8 of the U-SIG-2 portion.

In a further possible implementation form of the first aspect, the U-SIG field comprises a plurality of bits defining a U-SIG-1 portion and a U-SIG-2 portion, wherein bits 20-24 and/or bit 25 of the U-SIG-1 portion encode a spatial configuration and at least a portion of the management information is encoded in bit 2 and/or bit 8 of the U-SIG-2 portion.

In a further possible implementation form of the first aspect, the U-SIG field comprises a plurality of bits, wherein the plurality of bits comprises at least one or more of the following bits: 3 bits encoding a physical layer version identifier, 3 bits encoding a bandwidth, 1 bit encoding an uplink or downlink direction, 6 bits encoding a BSS color, 7 bits encoding a transmission opportunity TxOP, 4 bits encoding an BSS-specific offset value SS_index_offset indicative of a smallest index value assigned to the one or more first spatial streams, i.e. the spatial streams assigned to the one or more non-AP stations of the AP in the BSS, and/or 3 or 4 bits explicitly or implicitly indicative of the total number of the plurality of spatial streams in the coordinated beamforming set.

In a further possible implementation form of the first aspect, the 4 bits encoding the BSS-specific offset value SS_index_offset and the 3 or 4 bits explicitly or implicitly indicative of the total number of the plurality of spatial streams in the coordinated beamforming set are the 7 or 8 most or least significant bits of the plurality of bits of the U-SIG field.

In a further possible implementation form of the first aspect, the frame comprises a plurality of EHT-LTF symbols and wherein the information indicative explicitly or implicitly of the total number of the plurality of spatial streams in the coordinated beamforming set comprises a difference value (herein referred to as NSS_Total_Gap) between a total number of the plurality of EHT-LTF symbols and a total number of the plurality of spatial streams.

In a further possible implementation form of the first aspect, the frame comprises a plurality of EHT-LTF symbols and wherein the information indicative implicitly of the total number of the plurality of spatial streams in the coordinated beamforming set comprises the difference value NSS_Total_Gap between the total number of the plurality of EHT-LTF symbols and a total number of the plurality of spatial streams, if the difference value is smaller than the value 7, and otherwise the value 7.

In a further possible implementation form of the first aspect, the frame further comprises information for identifying each of the one or more first non-AP stations.

In a further possible implementation form of the first aspect, the AP is a sharing AP of the coordinated beamforming set configured to share a transmission opportunity TxOP with the at least one further AP of the coordinated beamforming set.

In a further possible implementation form of the first aspect, the AP is a shared AP of the coordinated beamforming set configured to use a transmission opportunity TxOP shared by the at least one further AP of the coordinated beamforming set.

According to a second aspect a method of operating an access point, AP, is provided, wherein the AP is configured to perform coordinated beamforming with at least one further AP of a coordinated beamforming set, wherein the AP is configured to communicate via one or more first spatial streams of a plurality of spatial streams with one or more first non-AP stations and the at least one further AP is configured to communicate via one or more second spatial streams of the plurality of spatial streams with one or more second non-AP stations. The method comprises the steps of:
obtaining information indicative of a total number of the plurality of spatial streams in the coordinated beamforming set; and
transmitting a frame to each of the one or more first non-AP stations, wherein the management frame comprises management information including the information indicative of the total number of the plurality of spatial streams in the coordinated beamforming set.

The method according to the second aspect of the present disclosure can be performed by the AP according to the first aspect of the present disclosure. Thus, further features of the method according to the second aspect of the present disclosure result directly from the functionality of the AP according to the first aspect of the present disclosure as well as its different implementation forms described above and below.

According to a third aspect a computer program product is provided, comprising a computer-readable storage medium for storing program code which causes a computer or a processor to perform the method according to the second aspect, when the program code is executed by the computer or the processor.

According to a further aspect an access point, AP, is provided, which is configured to perform coordinated beamforming with at least one further AP of a coordinated beamforming set. The AP is further configured to communicate via one or more first spatial streams of a plurality of spatial streams with one or more first non-AP stations and the at least one further, i.e. second AP is configured to communicate via one or more second spatial streams of the plurality of spatial streams with one or more second non-AP stations. The AP comprises a communication interface configured to transmit a frame to each of the one or more first non-AP stations associated with the AP, wherein the frame comprises a plurality of user fields, including one user field for each of the one or more first non-AP stations and a dummy user field for each of the one or more second non-AP stations. In other words, according to this aspect, the AP may replace user fields that belong to an Overlapping BSS (OBSS), i.e. the BSS of the further AP, with dummy user fields.

In a further possible implementation form, the dummy user fields may comprise a respective identifier of the one or more second non-AP stations.

In a further possible implementation form, the communication interface of the AP is configured to signal user fields in the frame in the amount of the total user fields of all BSSs, so that the content of the spatial configuration corresponds to all the spatial streams of the frame.

In a further possible implementation form, the total number of spatial streams, which may be extracted from the spatial configuration sub-field, may be the aggregated number of spatial streams transmitted by the AP and the further AP(s).

In a further possible implementation form, the order of the plurality of user fields of the frame may be set depending on the number of spatial streams of the AP and the further AP(s).

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows an exemplary wireless communication network configured according to a Multi User Multiple Input Multiple Output signalling method;

FIG. 2 shows a schematic diagram illustrating an exemplary EHT-Preamble of a communication frame;

FIG. 3 shows a schematic diagram illustrating an exemplary EHT-SIG field;

FIG. 4 shows a schematic diagram illustrating an exemplary EHT-SIG format;

FIG. 5 shows a schematic diagram illustrating signals for different spatial streams defining an exemplary P-Matrix;

FIG. 6 shows a schematic diagram illustrating Coordinated Beamforming of an access point with a further access point transmitting to a single station according to an embodiment;

FIG. 7 shows a schematic diagram illustrating Coordinated Beamforming of an access point with a further access point transmitting to multiple stations according to an embodiment;

FIG. 8 shows a schematic diagram illustrating dummy fields in user fields transmitted by an access point and a further access point according to an embodiment;

FIG. 9 shows a schematic diagram illustrating Coordinated Beamforming of an access point with a further access point according to an embodiment;

FIG. 10 shows a schematic diagram illustrating dummy fields in user fields transmitted by an access point and a further access point according to an embodiment;

FIG. 11 shows exemplary rows of a P-Matrix used by an access point and a further access point according to an embodiment; and

FIG. 12 is a flow diagram illustrating a method of operating an access point to perform coordinated beamforming with at least one further access point according to an embodiment.

In the following, identical reference signs refer to identical or at least functionally equivalent features.

### DETAILED DESCRIPTION OF THE EMBODIMENTS

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

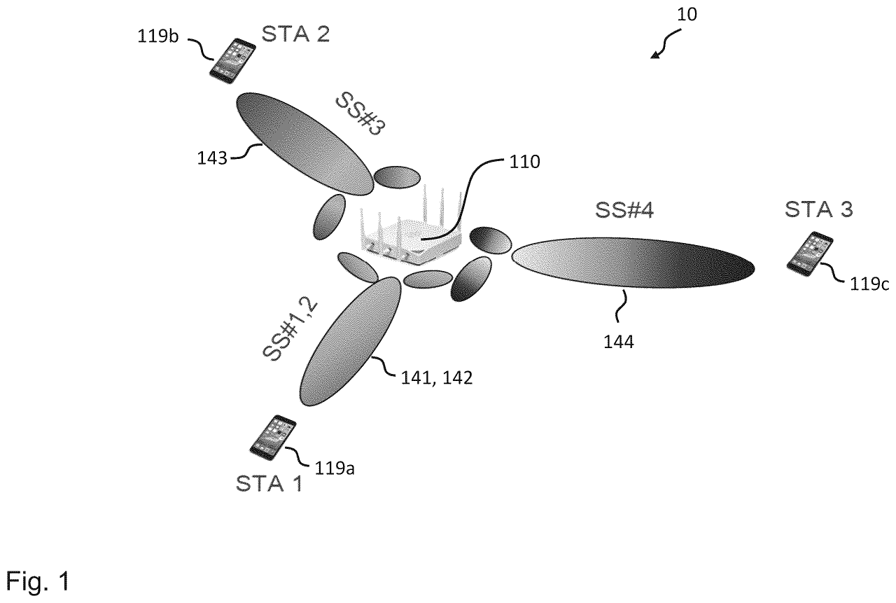

Before describing embodiments of the present disclosure, in the following some technical background as well as terminology concerning wireless networks and devices in accordance with the IEEE 802.11be WLAN standard will be introduced under reference to FIGS. 1 to 5. In the following one or more of the following acronyms may be used:
AP Access Point
BSS Basic Service Set
BW Bandwidth
CoBF Coordinated Beamforming
EHT Extreme High Throughput
LTF Long Training Field
MCS Modulation & Coding Scheme
MIMO Multiple Input Multiple Output
MU-MIMO Multi User Multiple Input Multiple Output
OBSS Overlap Basic Service Set
OFDMA Orthogonal Frequency Division Multiple Access
PLCP Physical Layer Convergence Protocol
PPDU PLCP Protocol Data Unit
SS spatial stream
STA Station (in general, can be either an AP STA or a non-AP STA)

FIG. 1 shows an exemplary wireless communication network 10 configured according to a Multi User Multiple Input Multiple Output (MU-MIMO) signaling method known from prior art and described below in more detail. In the example of FIG. 1, the AP 110 transmits a PLCP Protocol Data Unit (PPDU) 200 according to the Physical Layer Convergence Protocol (PLCP) to three non-AP stations 119a-c (referred to as STA 1-3 in FIG. 1) using an MU-MIMO signal. The AP 110 transmits four spatial streams to the three non-AP stations 119a-c, namely two spatial streams 141, 142 to non-AP station 119a, one spatial stream 143 to non-AP station 119b and one spatial stream 144 to non-AP station 119c.

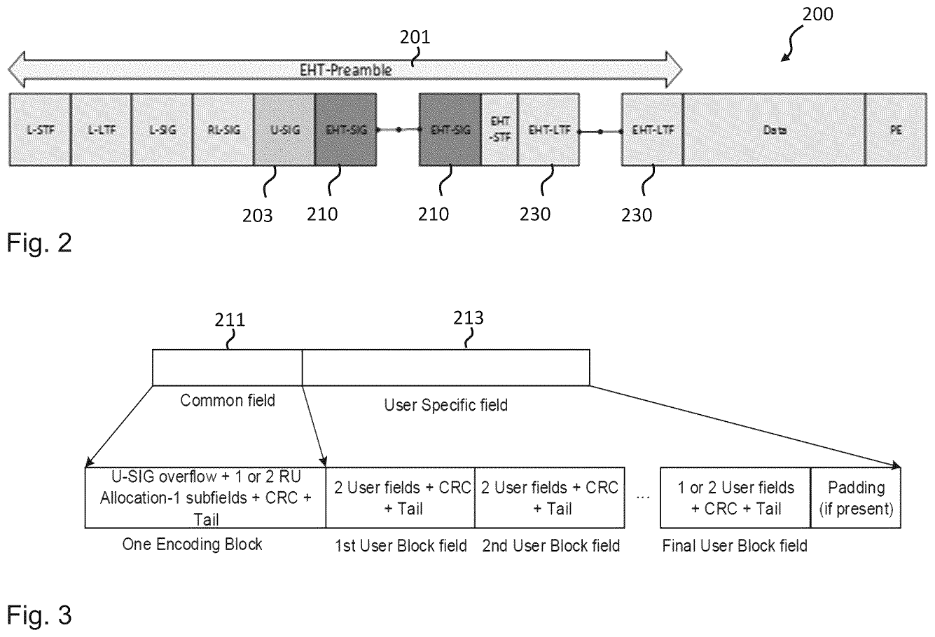

Each non-AP station 119a-c receives and decodes a preamble 201 in the PPDU 200 in the order of its fields as shown in FIG. 2. When reaching field EHT-SIG 210, the respective non-AP station 119a-c first extracts the number of EHT-LTF symbols 230 from the common part 211 of the field EHT-SIG 210, i.e. the EHT SIG common field 211 as illustrated in FIG. 3. This is required for properly estimating the Multiple Input Multiple Output (MIMO) channel.

As further illustrated in FIGS. 2 and 3, the respective non-AP station 119a-c in a conventional way parses the user-fields 213a-c in the user specific field 213 and searches for the user-field 213a-c with an identifier STA_ID of the respective non-AP station 119a-c that matches its own. When the matched identifier STA_ID is found, the respective non-AP station 119a-c extract the rest of the parameters (as shown in Tables 2 and 3) from the user-field 213a-c.

Table 1 summarizes the parameters that are required to allow proper transmitting and decoding of MU-MIMO in the prior art.

TABLE 1
MU-MIMO Parameters

| Parameter name | Signaled in field | Remark |
|---|---|---|
| N_{STAs} | EHT-SIG - User fields | Number of STAs in the MU-MIMO group |
| SS_{Index} | EHT-SIG - User fields | Spatial Stream/s index/indices |
| N_{SS} | EHT-SIG - User fields | Total number of spatial streams transmitted |
| | | to all STAs in the MU-MIMO group |
| N_{HE}_{_{—}}_{LTF} | EHT-SIG - Common | Number of EHT-LTF symbols (for channel |
| | field | estimation) |

The field U-SIG 203 comprises two Orthogonal Frequency-Division Multiplexing (OFDM) symbols that contain parameters which are common to the entire PPDU 200, e.g. Bandwidth (BW) and PPDU type and also contains several reserved bits for future use named “disregard” bits or “validate” bits.

The field EHT-SIG 210 contains two parts spread over several OFDM symbols as illustrated in FIG. 3. The first part of EHT-SIG 210, the “common field” 211, i.e. the EHT SIG common field 211 also contains two parts, namely U-SIG overflow and Resource Unit (RU) allocation subfields. The U-SIG overflow field includes some additional common parameters that were left out of the U-SIG 203 due to lack of room and comprises the number of EHT-LTF symbols 230, which is an important parameter further explained below related to MU-MIMO and CoBF. The RU allocation subfields contains the RU structure of each 20 MHz channel and the number of STAs in any MU-MIMO group is signaled here. The second part of EHT-SIG 210, the “User Specific Field” 213 contains the user fields 213a-c. Each user field 213a-c contains parameters of a specific STA, i.e. non-AP STA 119a-c, among them parameters required for properly decoding an MU-MIMO signal.

As will be appreciated, each non-AP STA 119a-c decodes and uses the information in its user-field 213a-c. Generally, there are two types of user fields 213a-c: user field 213a-c of a STA, i.e. non-AP STA 119a-c that is part of an MU-MIMO group and user field 213a-c of a non MU-MIMO STA, i.e. non-AP STA 119a-c. Table 2 shows the list of parameters in a non MU-MIMO user-field and Table 3 shows the list of parameters in a MU-MIMO user-field.

TABLE 2
User field for non-MU-MIMO STA

| Parameter name | Bit size |
|---|---|
| STA-ID | 11 |
| MCS | 4 |
| Coding | 1 |
| Spatial Configuration | 6 |

The Spatial Configuration field is defined in a special way. Given the number of STAs in the MU-MIMO group, it signals 2 parameters at the same time: indices of each STA's spatial streams and the total number of spatial streams.

TABLE 3
User field for MU-MIMO STA

| Parameter name | Bit size |
|---|---|
| STA-ID | 11 |
| MCS | 4 |
| NSS | 4 |
| Beamforming | 1 |
| Coding | 1 |

In both user field types according to Table 2 and 3 the first sub-field is the STA_ID. This field indicates to which non-AP STA 119a-c this user field belongs, indicating whether it needs to use the rest of the parameters in the user-field 213a-c or it should skip this user-field 213a-c and move to parse the next one.

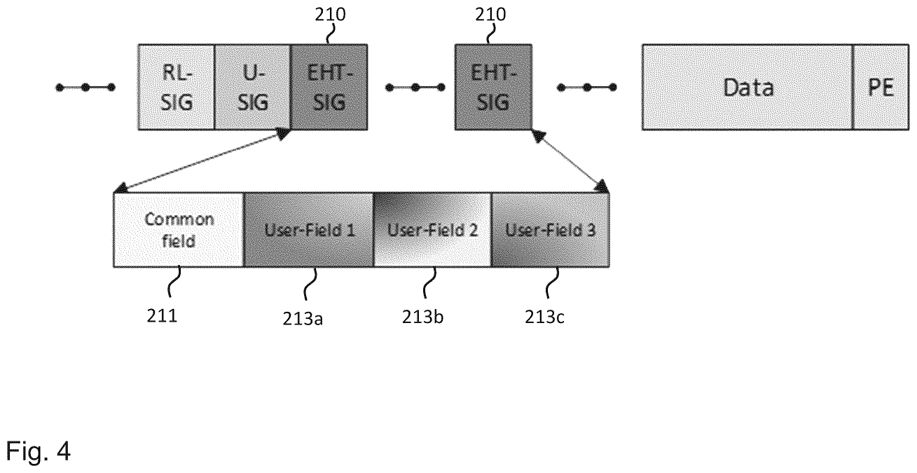

FIG. 4 above describes the user fields corresponding to the MU-MIMO scheme in the example given in FIG. 1. The Spatial Configuration field is the same in all user-fields 213a-c corresponding to the MU-MIMO STAs, i.e. non-AP STAs 119a-c and is set to [2, 1, 1] which means that: (i) one non-AP STA 119a-c has two spatial streams and each of the other two non-AP STA 119a-c has a single spatial stream; (ii) the total number of spatial streams in the MU-MIMO group is 4 (2+1+1); (iii) the non-AP STA 119a that identifies its STA_ID in user field 213a with index 0 is assigned spatial streams 141,142 with indices 0, 0 i.e. the first and the second SS indices; (iv) the non-AP STA 119b that identifies its STA_ID in user field 213b with index 2 is assigned spatial stream 143 with index 2, i.e. the third SS index; and (v) the non-AP STA 119c that identifies its STA_ID in user field 213c with index 3 is assigned spatial stream 144 with index 3, i.e. the fourth SS index.

After extracting the above information, each non-AP STA 119a-c uses its spatial streams indices and the total number of spatial streams when it processes the EHT-LTF symbols 230 for estimating the MIMO channel.

As will be appreciated, the indices of the spatial streams are used by the transmitter, i.e. the AP 110 when it produces the EHT-LTF symbols 230 in order to enable the receiver, i.e. the non-AP STA 119a-c to distinguish between the channels of each spatial stream 141-144 and to estimate only the channel(s) of its own spatial stream(s). The EHT-LTF symbols 230 are comprised of a basic sequence (which is the same in each symbol) that form a single OFDM symbol and is replicated NHE LTF times. These concatenated OFDM symbols are multiplied by a known bit-sequence (each bit is multiplied by one EHT-LTF OFDM symbol 230) to enable the receiver, i.e. the non-AP STA 119a-c to distinguish between them. Each bit-sequence is a row in the orthogonal matrix “P-Matrix” and it corresponds to an index of a specific spatial stream 141-144.

In the example shown in FIG. 1, the AP 110 transmits four spatial streams 141-144, so the 4×4 P-Matrix it uses is:

$${P}_{4 \times 4} = [ \begin{matrix}+ 1 & + 1 & + 1 & + 1 \\ + 1 & - 1 & + 1 & - 1 \\ + 1 & + 1 & - 1 & - 1 \\ + 1 & - 1 & - 1 & + 1\end{matrix} ]$$

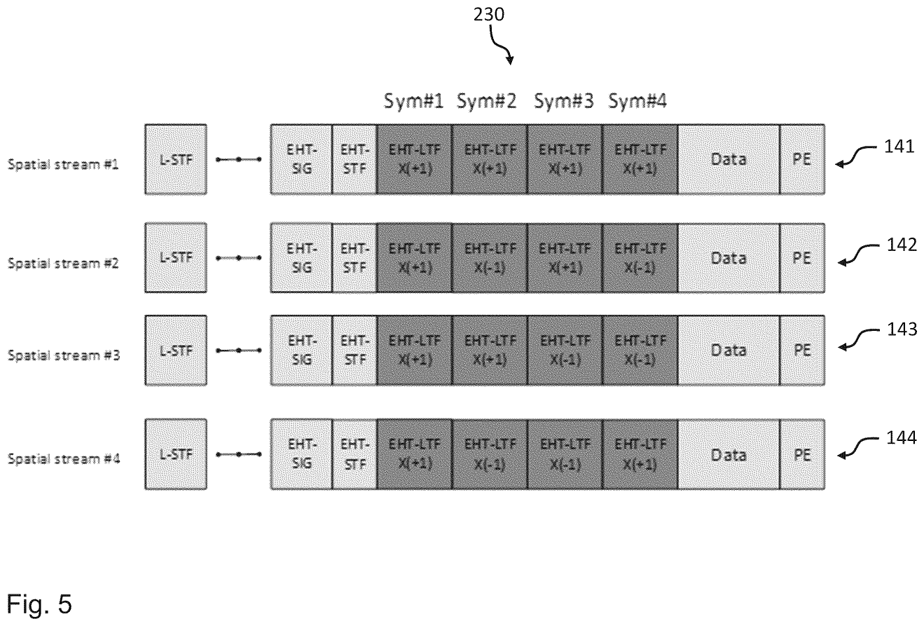

Each EHT-LTF symbol 230 is multiplied by the corresponding entry of the P-Matrix as illustrated in FIG. 5.

However, when multiple APs collaborate to transmit an MU-MIMO signal, they still need to indicate to their respective non-AP STA the total number of spatial streams and the index of each spatial stream. But in this case, the total number of spatial streams is the number of spatial streams transmitted by all the collaborating APs. In addition, the conventional signaling scheme assumes that all the indices of the spatial streams start from 0 (the first row of P-Matrix) which is not the case anymore, when multiple APs collaborate to transmit an MU-MIMO signal, because only one of the APs can use the first index for one of its transmitted spatial streams. Thus, and due to the above, Coordinated Beamforming (CoBF) cannot be supported by the conventional signaling scheme.

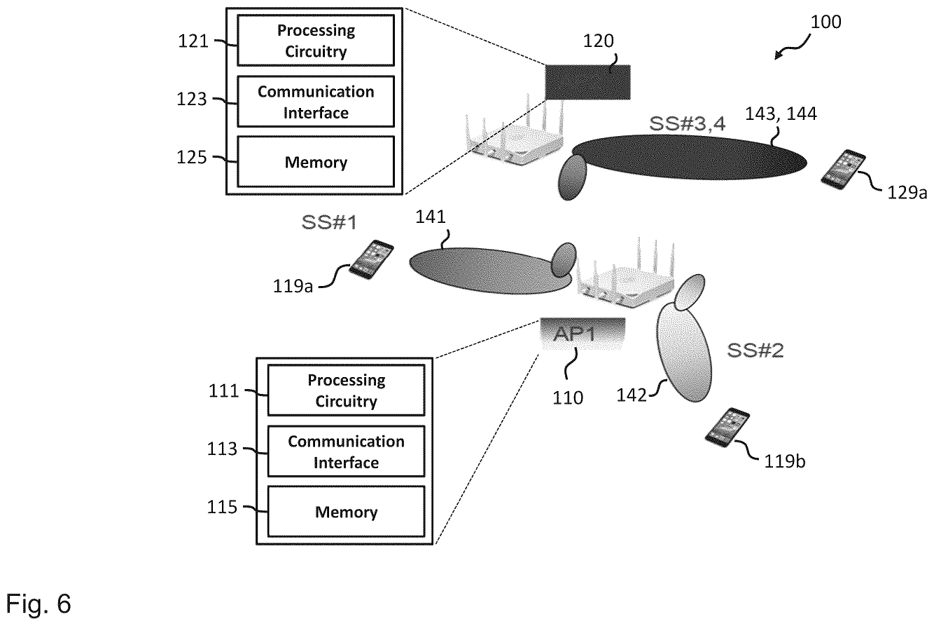

FIG. 6 is a schematic diagram illustrating an access point, AP, 110 configured to perform coordinated beamforming with at least one further AP 120 in a CoBF set 100 according to a first embodiment. As illustrated in FIG. 6, the AP 110 is configured to communicate via one or more first spatial streams 141, 142 of a plurality of spatial streams 141-144 with one or more first non-AP stations 119a, 119b and the further AP 120 is configured to communicate via one or more second spatial streams 143, 144 of the plurality of spatial streams 141-144 with one or more second non-AP stations 129a.

As illustrated in FIG. 6, the AP 110 comprises a processing circuitry 111 configured to obtain information indicative of a total number of the plurality of spatial streams. The processing circuitry 111 may be implemented in hardware and/or software and may comprise digital circuitry, or both analog and digital circuitry. Digital circuitry may comprise components such as application-specific integrated circuits (ASICs), field-programmable arrays (FPGAs), digital signal processors (DSPs), or general-purpose processors. The AP 110 may further comprise a memory 115 configured to store executable program code which, when executed by the processing circuitry 111, causes the AP 110 to perform the functions and methods described herein.

The AP 110 further comprises a communication interface 113 configured to transmit a PPDU including a frame 200 to each of the one or more first non-AP stations 119a-c, wherein the frame 200 comprises management information including the information indicative of the total number of the plurality of spatial streams. The further AP 120 may comprise a processing circuitry 121, a communication interface 123 and a memory 125 and may be respectively configured as the AP 110 in the embodiments above and below for transmitting a frame 200 to each of the one or more second non-AP stations 129a.

According to a second embodiment, the AP 110 may be configured to support CoBF based on the changes of the 802.11be signalling described below. The information indicative of the total number of the plurality of spatial streams 141-144 may be an indication of the aggregated number of spatial streams 141-144 transmitted by all APs 110, 120 in the CoBF set 100. Thus, the frame 200 for each of the one or more first non-AP stations 119a, 119b may comprise the parameters “NSS Total” or “NSS Total Gap”, which will be described in more detail further below. The frame 200 may further comprise an indication of the exact spatial stream (SS) indices allowing the lowest SS index in the BSS to be greater than 1. Thus, the frame 200 may comprise a “SS_index_offset” as an offset to the spatial stream index that is defined in the spatial configuration field or the N_SS field of the 802.11be signaling scheme. The above indications may be added to the fields U-SIG 203 and/or EHT-SIG 210 as described in the embodiments below.

According to a third embodiment, one of the APs 110, 120 may transmit to a single non-AP STA 129a in the BSS on the full BW, i.e. beamforming the spatial streams 141-144, which is illustrated in FIG. 6 by way of example for the AP 120 using spatial streams 143, 144. The AP 120 may indicate the SS_index_offset to the non-AP STA 129a and the number of spatial streams (SS) 143, 144 of the non-AP STA 129a. The non-AP STA 129a may use this offset to calculate its SS indices by summing it with its number of SS 143, 144. The AP 120 may also indicate the total number of SS 141-144, NSS_Total, transmitted by all coordinating APs 110, 120. In the frame 200, the SS_index_offset (the first SS index in the BSS) and NSS_Total may be located in the user field 213a-c of the EHT-SIG 210 field corresponding to the non-AP stations 129a-c as shown in Table 4.

TABLE 4
User field for CoBF AP transmitting to a single user

| Subfield | Number of bits |
|---|---|
| STA-ID | 11 |
| MCS | 4 |
| NSS | 4 |
| Beamforming | 1 |
| Coding | 1 |
| SS_index_offset | 4 |
| NSS_Total | 4 (3) |

Specifically, each user field 213a-c may comprise a plurality of bits. The plurality of bits may comprise at least one or more of the following bits: 11 bits encoding an identifier STA-ID of the respective first non-AP station 119a-c, 4 bits encoding a modulation and coding scheme MCS, 4 bits encoding a total number NSS of the one or more first non-AP stations 119a-c, 1 bit encoding a beamforming mode Beamforming, 1 bit encoding a coding scheme Coding, 4 bits encoding the BSS-specific offset value SS_index_offset indicative of a smallest index value assigned to the one or more first spatial streams 141-144 (any index may be assigned to only one spatial stream) and the field NSS_Total indicative of the total number of the plurality of spatial streams 141-144 in the coordinated beamforming set 100.

The NSS_Total field may require 4 bits for explicit signaling. In an embodiment described further below, 3 bits are required by alternatively implicitly signaling the total number of the plurality of spatial streams 141-144 with a parameter NSS_Total_Gap. In the exemplary embodiment according to FIG. 6, the AP 120 signals the additional parameters SS_index_offset with value 2 and NSS_Total with value 4 to its single non-AP station 129a.

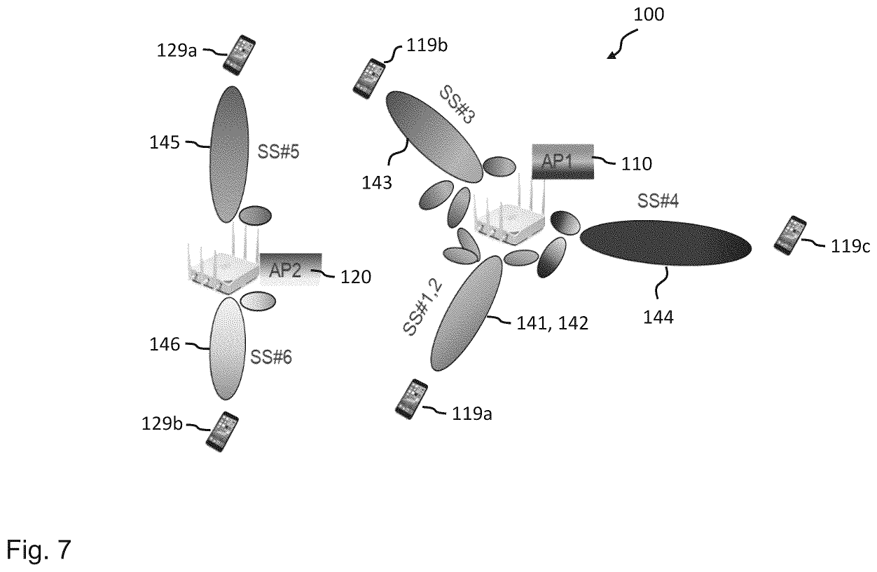

FIG. 7 shows a schematic diagram illustrating Coordinated Beamforming of an access point with a further access point transmitting to multiple stations according to a fourth embodiment. One of the AP 110,120 may transmit to multiple non-AP STA 119a-c, 129a-b in the BSS on the full BW, i.e. beamforming the spatial streams 141-146 as illustrated in FIG. 7. As will be appreciated, the AP 110 with the non-AP STAs 119a-c form a BSS and the AP 120 and its non-AP STAs 129a-b form a further different BSS. Each AP 110, 120 may indicate to its non-AP STAs 119a-c, 129a-b the SS index offset which is common to the BSS. Moreover, each non-AP STA 119a-c, 129a-b may use this offset to calculate its SS indices by summing it with its corresponding SS index/indices as derived from the spatial configuration field. The SS_index_offset (i.e. first SS index in the BSS) and NSS_Total may be located in the user field 213a-c of the EHT-SIG field 210 corresponding to the non-AP STA 119a-c, 129a-b. The user field content for CoBF transmission from the AP 110, 120 to multiple STAs, i.e. non-AP STA 119a-c, 192 a-b in a non-OFDMA transmission may therefore be based on the user-field 213 in non-OFDMA transmission as defined in 802.11be with the addition of the two parameters SS_index_offset and NSS_Total as shown in Table 5.

TABLE 5
User field for CoBF AP transmitting to multiple users

| Subfield | Number of bits |
|---|---|
| STA-ID | 11 |
| MCS | 4 |
| Coding | 1 |
| Spatial Configuration | 6 |
| SS_index_offset | 4 |
| NSS_Total | 4 (3) |

Specifically, each user field 213a-c may comprise a plurality of bits. The plurality of bits may comprise at least one or more of the following bits: 11 bits encoding the identifier STA-ID of the respective first non-AP station 119a-c, 4 bits encoding the modulation and coding scheme MCS, 1 bit encoding the coding scheme Coding, 6 bits encoding a spatial configuration, 4 bits encoding the BSS-specific offset value SS_index_offset indicative of a smallest index value assigned to the one or more first spatial streams 141-144, and 3 or 4 bits explicitly or implicitly indicative of the total number of the plurality of spatial streams 141-146 in the coordinated beamforming set 100, in particular the field NSS_Total.

The difference with respect to 802.11be is in the way the receiver, i.e. non-AP STA 119a-c, 129a-b uses the spatial configuration sub-field. Contrary to 802.11be, in CoBF the receiver, i.e. non-AP STA 119a-c, 129a-b must take into account the index offset in order to properly parse the correct index/indices of its spatial stream(s) 141-146. In the exemplary embodiment shown in FIG. 7, the AP 110 signals the additional parameters SS_index_offset with value 0 and NSS_Total with value 6, whereas the AP 120 signals the additional parameters SS_index_offset with value 4 and NSS_Total with value 6.

According to a fifth embodiment, both parameters SS_index_offset and the NSS_Total are signaled in the EHT SIG-common field 211 and are added to the existing (as defined in EHT-Release-1, i.e. the 802.11be standard, for MU-MIMO signaling) parameters as shown in Table 6.

TABLE 6
EHT-SIG common field

| Subfield | Number of bits |
|---|---|
| Spatial Reuse | 4 |
| GI + LTF Size | 2 |
| Number of EHT-LTF Symbols | 3 |
| LDPC Extra Symbol Segment | 1 |
| Pre-FEC Padding Factor | 2 |
| PE Disambiguity | 1 |
| Number of non-OFDMA users | 3 |
| SS_index_offset | 4 |
| NSS_Total | 4 (3) |

Specifically, each EHT SIG common field 211 may comprise a plurality of bits. The plurality of bits may comprise at least one or more of the following bits: 4 bits encoding a Spatial Reuse configuration, 2 bits encoding a guard interval GI and EHT training field EHT-LTF size, 3 bits encoding a number of EHT training field EHT-LTF symbols, 1 bit encoding a LDPC extra symbol segment, 2 bits encoding a pre-FEC padding factor, 1 bit encoding a PE disambiguity, 3 bits encoding a number of non-OFDMA user, 4 bits encoding the BSS-specific offset value SS_index_offset indicative of a smallest index value assigned to the one or more first spatial streams 141-144 and/or 3 or 4 bits explicitly or implicitly indicative of the total number of the plurality of spatial streams 141-146 in the coordinated beamforming set 100, in particular the field NSS_Total.

According to a sixth embodiment, both parameters SS_index_offset and NSS_Total may be signaled in U-SIG 203 and/or the EHT SIG-common field 211 on the expense of existing disregard and/or validate bits (as defined in EHT-Release-1). Thus, user field size may be reduced compared to the third and fourth embodiment. The U-SIG field 203 may comprise a plurality of bits defining a U-SIG-1 portion and a U-SIG-2 portion. Possible locations for SS_index_offset and/or NSS_Total may comprise the bits B20-B24 in U-SIG-1 (disregard bits), B13-B16 in EHT SIG-Common field 211 (disregard bits), B25 in U-SIG-1 (validate bit), B2 in U-SIG-2 (validate bit) and/or B8 in U-SIG-2 (validate bit).

According to a seventh embodiment, the parameter SS_index_offset may replace the Spatial Reuse (SR) field in EHT SIG-Common field 211. Parameter NSS_total may be added to the EHT SIG-common field 211, in particular similar to the fifth embodiment, or to the U-SIG 203, in particular similar to the sixth embodiment. Thus, the user field size may be reduced compared to the third and fourth embodiment and the size of EHT SIG-common field 211 itself may be reduced compared to the fifth embodiment. Replacing the Spatial Reuse field as shown in Table 7 may be possible as SR may be redundant when CoBF is used.

TABLE 7
EHT-SIG common field

| | Number |
|---|---|
| Subfield | of bits |
| SS_index_offset (instead of Spatial Reuse) | 4 |
| GI + LTF Size | 2 |
| Number of EHT-LTF Symbols | 3 |
| LDPC Extra Symbol Segment | 1 |
| Pre-FEC Padding Factor | 2 |
| PE Disambiguity | 1 |
| Number of non-OFDMA users | 3 |
| NSS_Total | 4 (3) |

Specifically, each EHT SIG common field 211 may comprise a plurality of bits. The plurality of bits may comprise at least one or more of the following bits: 4 bits encoding the BSS-specific offset value SS_index_offset indicative of a smallest index value assigned to the one or more first spatial streams 141-144, 2 bits encoding the guard interval GI and EHT training field EHT-LTF size, 3 bits encoding the number of EHT training field EHT-LTF symbols, 1 bit encoding the LDPC extra symbol segment, 2 bits encoding the pre-FEC padding factor, 1 bit encoding the PE disambiguity, 3 bits encoding the number of non-OFDMA user and/or 3 or 4 bits explicitly or implicitly indicative of the total number of the plurality of spatial streams 141-146 in the coordinated beamforming set 100, in particular the field NSS_Total.

The 4 bits encoding the BSS-specific offset value SS_index_offset may be the 4 most significant bits of the EHT SIG common field 211 and the 3 or 4 bits explicitly or implicitly indicative of the total number of the plurality of spatial streams 141-146 in the coordinated beamforming set 100 may be the 3 or 4 least significant bits of the EHT SIG common field 211.

According to an eighth embodiment, NSS_total may replace the Spatial Reuse field in the EHT SIG-Common field 211. SS_index_offset may be added to EHT SIG-common field 211, in particular similar to the fifth embodiment, or to U-SIG 203, in particular similar to the sixth embodiment. Thus, the user field size may be reduced compared to the third and fourth embodiment and the size of EHT SIG-common field 211 itself compared to the fifth embodiment. Replacing the Spatial Reuse field as shown in Table 8 may be possible as SR may be redundant when CoBF is used.

TABLE 8
EHT-SIG common field

| Subfield | Number of bits |
|---|---|
| NSS_Total (instead of Spatial Reuse) | 4 (3) |
| GI + LTF Size | 2 |
| Number of EHT-LTF Symbols | 3 |
| LDPC Extra Symbol Segment | 1 |
| Pre-FEC Padding Factor | 2 |
| PE Disambiguity | 1 |
| Number of non-OFDMA users | 3 |
| SS_index_offset | 4 |

Specifically, each EHT SIG common field 211 may comprise a plurality of bits. The plurality of bits may comprise at least one or more of the following bits: 4 bits encoding the BSS-specific offset value SS_index_offset indicative of a smallest index value assigned to the one or more first spatial streams 141-144, 2 bits encoding the guard interval GI and EHT training field EHT-LTF size, 3 bits encoding the number of EHT training field EHT-LTF symbols, 1 bit encoding the LDPC extra symbol segment, 2 bits encoding the pre-FEC padding factor, 1 bit encoding the PE disambiguity, 3 bits encoding the number of non-OFDMA user and/or 3 or 4 bits explicitly or implicitly indicative of the total number of the plurality of spatial streams 141-146 in the coordinated beamforming set 100, in particular the field NSS_Total.

The 4 bits encoding the BSS-specific offset value SS_index_offset may be the 4 least significant bits of the EHT SIG common field 211 and the 3 or 4 bits explicitly or implicitly indicative of the total number of the plurality of spatial streams 141-146 in the coordinated beamforming set 100 may be the 3 or 4 most significant bits of the EHT SIG common field 211.

According to a ninth embodiment, SS_index_offset may replace Spatial Reuse field in the EHT SIG-Common field 211 as shown in Table 9, and NSS_total may be placed in the user field 213, in particular similar to the third or fourth embodiment. Replacing the Spatial Reuse field as shown in Table 9 may be possible as SR may be redundant when CoBF is used.

TABLE 9
EHT-SIG common field

| | Number |
|---|---|
| Subfield | of bits |
| SS_index_offset (instead of Spatial Reuse) | 4 |
| GI + LTF Size | 2 |
| Number of EHT-LTF Symbols | 3 |
| LDPC Extra Symbol Segment | 1 |
| Pre-FEC Padding Factor | 2 |
| PE Disambiguity | 1 |
| Number of non-OFDMA users | 3 |

Specifically, each EHT SIG common field 211 may comprise a plurality of bits. The plurality of bits may comprise at least one or more of the following bits: 4 bits encoding the BSS-specific offset value SS_index_offset indicative of a smallest index value assigned to the one or more first spatial streams 141-144, 2 bits encoding the guard interval GI and EHT training field EHT-LTF size, 3 bits encoding the number of EHT training field EHT-LTF symbols, 1 bit encoding the LDPC extra symbol segment, 2 bits encoding the pre-FEC padding factor, 1 bit encoding the PE disambiguity, and/or 3 bits encoding the number of non-OFDMA user.

The 4 bits encoding the BSS-specific offset value SS_index_offset may be the 4 most significant bits of the EHT SIG common field 211.

According to a tenth embodiment, NSS_total may replace the Spatial Reuse field in the EHT SIG-Common field 211 as shown in Table 10, and SS_index_offset may be placed in the user field 213, in particular similar to the third or fourth embodiment. Replacing the Spatial Reuse field (as shown in Table 10) may be possible as SR may be redundant when CoBF is used.

TABLE 10
EHT-SIG common field

| Subfield | Number of bits |
|---|---|
| NSS_total (instead of Spatial Reuse) | 4 (3) |
| GI + LTF Size | 2 |
| Number of EHT-LTF Symbols | 3 |
| LDPC Extra Symbol Segment | 1 |
| Pre-FEC Padding Factor | 2 |
| PE Disambiguity | 1 |
| Number of non-OFDMA users | 3 |

Specifically, each EHT SIG common field 211 may comprise a plurality of bits. The plurality of bits may comprise at least one or more of the following bits: 2 bits encoding the guard interval GI and EHT training field EHT-LTF size, 3 bits encoding the number of EHT training field EHT-LTF symbols, 1 bit encoding the LDPC extra symbol segment, 2 bits encoding the pre-FEC padding factor, 1 bit encoding the PE disambiguity, 3 bits encoding the number of non-OFDMA user and/or 3 or 4 bits explicitly or implicitly indicative of the total number of the plurality of spatial streams 141-146 in the coordinated beamforming set 100, in particular the field NSS_Total.

The 3 or 4 bits explicitly or implicitly indicative of the total number of the plurality of spatial streams 141-146 in the coordinated beamforming set 100 may be the 3 or 4 most significant bits of the EHT SIG common field 211.

According to an eleventh embodiment, SS_index_offset may be placed in U-SIG 203, in particular similar to the sixth embodiment, and NSS_total may be placed in the user field 213, in particular similar to the third or fourth embodiment. The content of a user field corresponding to the case where an AP 110, 120 transmits to a single non-AP STA 119a-c, 129 a-b is shown in Table 11 and the case where an AP 110, 120 transmits to multiple non-AP STA 119a-c, 129 a-b is shown in Table 12.

TABLE 11
User Field when AP transmit to a single STA

| Subfield | Number of bits |
|---|---|
| STA-ID | 11 |
| MCS | 4 |
| NSS | 4 |
| Beamforming | 1 |
| Coding | 1 |
| NSS_Total | 4 (3) |

TABLE 12
User Field when AP transmit to multiple STAs

| Subfield | Number of bits |
|---|---|
| STA-ID | 11 |
| MCS | 4 |
| Coding | 1 |
| Spatial Configuration | 6 |
| NSS_Total | 4 (3) |

According to a twelfth embodiment, NSS_total may be placed in U-SIG 203, in particular similar to the sixth embodiment, and SS_index_offset may be placed in the user field 213, in particular similar to the third or fourth embodiment. The content of a user field 213 corresponding to the case where an AP 110, 120 transmits to a single non-AP STA 119a-c, 129 a-b is shown in Table 13 and the case where an AP 110, 120 transmits to multiple non-AP STA 119a-c, 129 a-b is shown in Table 14.

TABLE 13
User Field when AP transmit to a single STA

| Subfield | Number of bits |
|---|---|
| STA-ID | 11 |
| MCS | 4 |
| NSS | 4 |
| Beamforming | 1 |
| Coding | 1 |
| SS_index_offset | 4 |

TABLE 14
User Field when AP transmit to multiple STAs

| Subfield | Number of bits |
|---|---|
| STA-ID | 11 |
| MCS | 4 |
| Coding | 1 |
| Spatial Configuration | 6 |
| SS_index_offset | 4 |

According to a thirteenth embodiment, the processing circuits 111, 121 of the AP 110, 120 may be configured for optimizing overhead and thus for efficient signaling in means of overhead. Since CoBF may be transmitted over the entire BW, repeating the same parameter in each user-field may increase overhead. Therefore, the spatial configuration as well as SS_offset_index and NSS_Total may be placed in U-SIG 203 and/or the EHT SIG-Common 211. This differs from the fifth to eighth embodiments which keep user fields 213 similar to EHT-Release-1.

For reducing overhead, the processing circuits 111, 121 of the AP 110, 120 may be configured to implement a method having the following steps: (i) If the AP 110, 120 transmits to more than one non-AP STA 119a-c, 129 a-b in the BSS, then the spatial configuration field shall be placed in B20-B24 of U-SIG-1 (disregard bits in EHT-Release-1) and B25 of U-SIG-1 (validate bit in EHT-Release-1). (ii) In case of transmission to a single non-AP STA 119a-c, 129 a-b, NSS shall be moved to B20-B23 of U-SIG-1.

(iii) SS_offset_index shall be placed similar as in the fifth, seventh, eighth or ninth embodiment. (iv) NSS_Total shall be placed similar as in the fifth, seventh, eighth or tenth embodiment.

An example of how to signal U-SIG 203, the EHT-SIG-Common field 211 and user field 213 is given in Tables 15, 16 and 17.

TABLE 15
U-SIG-1

| | | Number |
|---|---|---|
| Bit | Subfield | of bits |
| B0-B2 | PHY Version Identifier | 3 |
| B3-B5 | BW | 3 |
| B6 | UL/DL | 1 |
| B7-B12 | BSS Color | 6 |
| B13-B19 | TXOP | 7 |
| B20-B25 | Disregard (B20-B24) & | 6 |
| | Validate (B25) | |
| | Spatial Config (B0-B5) | |

TABLE 16
EHT SIG-Common field

| | | Number |
|---|---|---|
| Bit | Subfield | of bits |
| B0-B3 | SS_Index_offset | 4 |
| B4-B5 | GI + LTF Size | 2 |
| B6-B8 | Number of EHT-LTF Symbols | 3 |
| B9 | LDPC Extra Symbol Segment | 1 |
| B10-B11 | Pre-FEC Padding Factr | 2 |
| B12 | PE Disambiguity | 1 |
| B13-B16 | Disregard N_SS Total | 4 |
| B17-B19 | Number of Non-OFDMA Users | 3 |

TABLE 17
User field

| | Number |
|---|---|
| Subfield | of bits |
| STA-ID | 11 |
| MCS | 4 |
| Coding | 1 |
| Spatial Configuration | 6 |

According to a fourteenth embodiment, a method for further overhead reduction is provided. The field NSS_Total according to one of the previous embodiments may be replaced by the field “NSS_Total_Gap” which is i.e. a difference value. The processing circuit 111 of the AP 110 may determine the difference value NSS_Total_Gap (i) based on the limiting restriction NSS_{Total}<=N_{LTF}, whereas N_{LTF} is the total number of the plurality of EHT-LTF symbols 230, (ii) by defining that NSS_{Total}≥[½(N_{LTF}−1)], (iii) thus restricting [½(N_{LTF}−1)]≤NSS_{Total}≤N_{LTF} and therefore determining NSS_Total_Gap=min(N_{LTF}−NSS_{Total}, 7), which requires 3 bits. The receiving STA, i.e. the non-AP STA 119a-c, 129a-b may then estimate NSS_Total based on NSS_Total_Gap and the restrictions above.

There may be cases in which the actual NSS_Total_Gap is higher than the signaled one. This may happen for example when NSS_{Total}=7 and N_{LTF}=16 in a “worst case” scenario. In this case N_{LTF}—NSS_{Total}=16−7=9, however the signaled value of NSS_Total_Gap would be 7, meaning that a receiving STA, i.e. the non-AP STA 219a-c, 229a-b will assume that total of 9 spatial stream were transmitted, whereas only 7 spatial stream were effectively transmitted. However, these cases are less likely and do not degrade the receiving STA, i.e. the non-AP STA 219a-c, 229a-b performance by much.

According to a fifteenth embodiment, the method according to the fourteenth embodiment may comprise adding the further restriction NSS_{Total}≤[½(N_{LTF}−1)]. In this case the processing circuitry 111 may determine NSS_Total_Gap by N_{LTF}—NSS_{Total}, which also requires 3 bits. Contrary to the method according to the fourteenth embodiment, the exact number of NSS_{Total} may thus always be indicated by the AP 110. For example, considering the “worst case” where may be NSS_{Total}=7: the maximum number of LTFs 230 in this case is 14 (and not 16 as in the Method according to the fourteenth embodiment), so the processing circuitry 111 may determine NSS_Total_Gap=7.

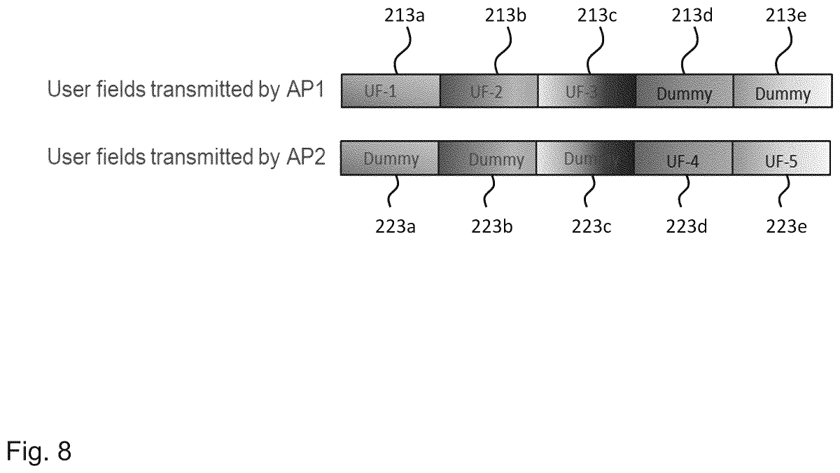

FIG. 8 shows a schematic diagram illustrating dummy fields in user fields transmitted by the access point 110 and the further access point 120 according to a sixteenth embodiment. The processing circuitry 111 of the AP 110 may replace user-fields 213a-e that belong to an Overlapping BSS (OBSS), i.e. the BSS of the further AP 120, with dummy user-fields 213a-e, in particular by using a dedicated STA-Identifier. As will be apricated, the further AP 120 may respectively replace user-fields 223a-e that belong to an Overlapping BSS (OBSS), i.e. the BSS of the AP 110.

The 802.11be user-field signaling scheme may be reused and may remain unchanged. However, each AP 110, 120 may signal user-fields 213a-e, 223a-e in the amount of the total user-fields of all BSSs, so the content of the spatial configuration corresponds to all the SS 141-146 of the PPDU 200, i.e. frame 200. An SS offset index may not be required.

User-fields 213a-e, 223a-e that respectively belong to the BSS of the AP 110, 120 may be used similar to 802.11be. A STA-Identifier may be unique to each STA in the CoBF set 100. In other words, two or more STA participating in the CoBF PPDU 200, i.e. frame 200 may not have the same STA-Identifier. This may be defined as part of the coordination set phase. In particular, the STA-identifier may be a new identifier that is dedicated to the M-AP set, stored in the memory 115, 125 which can be executed by the processing circuitry 111, 121 of the AP 110, 120 and/or which can be implemented by respective hardware of the non-AP STA 119a-c, 129a-c. No further details will be described here, as this aspect is outside of the scope of the embodiments disclosed herein.

The total number of SS 141-146, which may be extracted from the spatial configuration sub-field, may be the aggregated number of SS 141-146 transmitted by all AP 110, 120. This is contrary to the prior art case of MU-MIMO in 802.11be discussed above, where the total number of SS 141-146 always correspond to the BSS AP 110 only, i.e. the prior art case does not take into account OBSS's spatial streams, i.e. the spatial streams of the further AP 120.

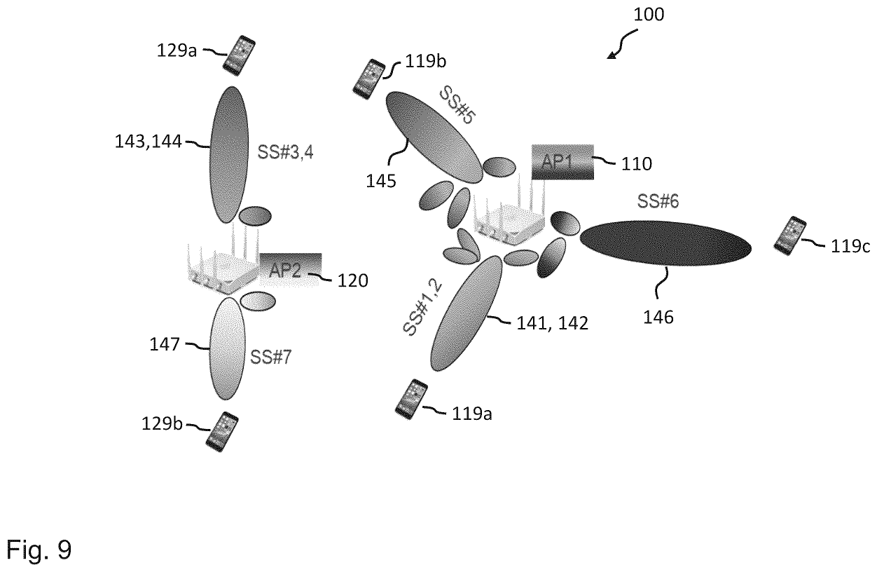

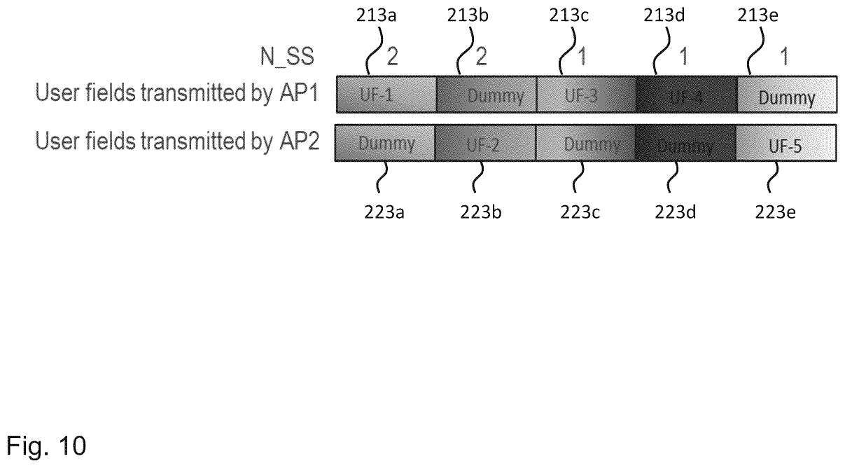

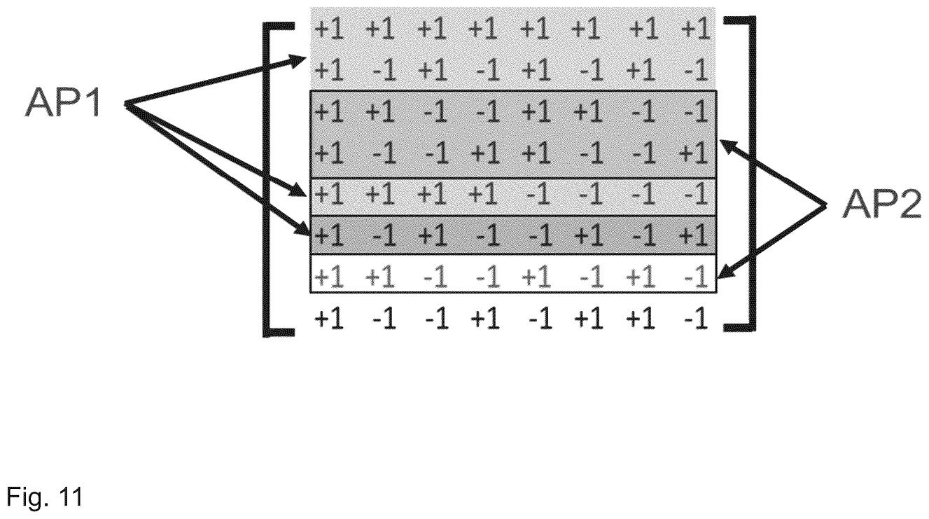

In a further example, as illustrated in FIGS. 9 and 10, the AP 110, 120 may transmit various numbers of SS 141-147. The 802.11be spatial configuration may be reused taking into account that its content is arranged in descending order, e.g. in the exemplary order [2,2,1,1,1]. Hence each AP 110, 120 contributes both one SS 145, 146, 147 and two SS 141, 142, 143, 144 to their respectively associated non-AP STA 119a-c, 129a-b. The order of user fields 213a-c, 223a-e may be set according to the number of SS 141-147 to the respective non-AP STA 119a-c, 129a-b, as illustrated in FIG. 10. This means that each AP 110, 120 may use non-continuous rows of the P-Matrix as shown in FIG. 11, which is not supported in the prior art case of MU-MIMO in 802.11be discussed above. As will be appreciated, all coordinated APs 110, 120 transmit different EHT SIG 210 because of the differences in the user specific field 213, i.e. the user fields 213a-c, 223a-c.

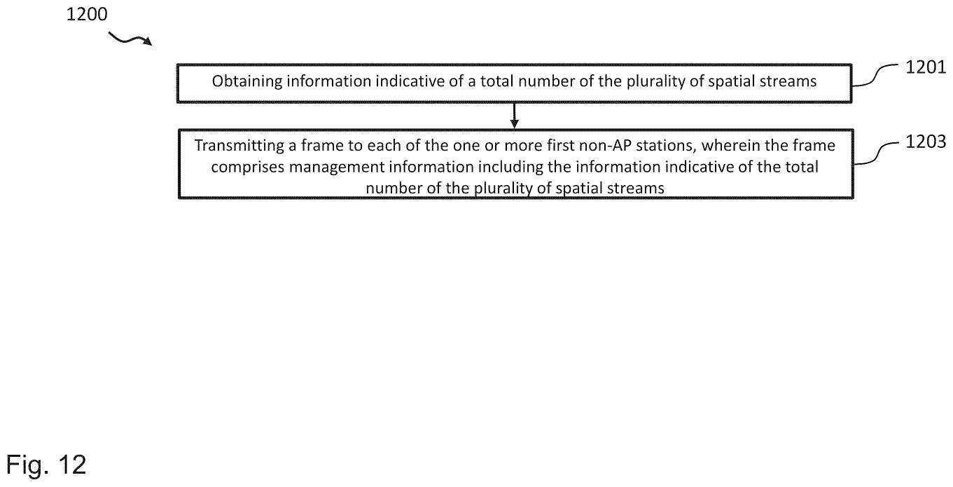

As illustrated in FIG. 12, a method 1200 of operating the AP 110 is provided, wherein the AP 110 is configured to perform coordinated beamforming with the at least one further AP 120, wherein the AP 110 is configured to communicate via one or more first spatial streams of a plurality of spatial streams 141-147 with one or more first non-AP stations 119a-c and the further AP 120 is configured to communicate via one or more second spatial streams of the plurality of spatial streams 141-147 with one or more second non-AP stations 129a-b.

The method 1200 comprises a step of obtaining 1201 information indicative of a total number of the plurality of spatial streams 141-147.

The method 1200 comprises a further step of transmitting 1203 a frame 200 to each of the one or more first non-AP stations 119a-c, wherein the frame 200 comprises management information including the information indicative of the total number of the plurality of spatial streams 141-147.

The method 1200 can be performed by the AP 110 according to an embodiment. Thus, further features of the method 1200 result directly from the functionality of the AP 110 as well as its different embodiments described above and below.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments disclosed herein may be integrated into one processing unit, or each of the units may exist alone physically, or two or more units are integrated into one unit.

1. An access point, AP, configured to perform coordinated beamforming with at least one further AP, wherein the AP is configured to communicate via one or more first spatial streams of a plurality of spatial streams with one or more first non-AP stations and the further AP is configured to communicate via one or more second spatial streams of the plurality of spatial streams with one or more second non-AP stations, wherein the AP comprises:
a processing circuitry configured to obtain information indicative of a total number of the plurality of spatial streams; and
a communication interface configured to transmit a frame to each of the one or more first non-AP stations, wherein the frame comprises management information including the information indicative of the total number of the plurality of spatial streams.

2. The AP of claim 1, wherein for each of the one or more first non-AP stations the management information further comprises information indicative of a number of spatial streams of the one or more first spatial streams assigned to the respective first non-AP station.

3. The AP of claim 1, wherein for each of the one or more first non-AP stations the management information further comprises information indicative of one or more index values of one or more spatial streams of a subset of the one or more first spatial streams, wherein the subset of the one or more first spatial streams is assigned to the respective first non-AP station.

4. The AP of claim 3, wherein the processing circuitry is further configured to assign a respective subset of the one or more first spatial streams to the respective first non-AP station and/or one or more index values to the respective subset of the one or more first spatial streams of the respective first non-AP station.

5. The AP of claim 1, wherein the information indicative of the total number of the plurality of spatial streams comprises the total number of the plurality of spatial streams.

6. The AP of claim 1, wherein the frame further comprises an offset value indicative of a smallest index value assigned to the one or more first spatial streams.

7. The AP of claim 1, where the frame comprises a user field for each of the one or more first stations and wherein each user field comprises at least a portion of the management information.

8. The AP of claim 7, wherein each user field comprises a plurality of bits, wherein the plurality of bits comprises at least one or more of the following bits: 11 bits encoding an identifier of the respective first non-AP station, 4 bits encoding a modulation and coding scheme, 4 bits encoding a total number of the one or more first non-AP stations, 1 bit encoding a beamforming mode, 1 bit encoding a coding scheme, 4 bits encoding an offset value indicative of a smallest index value assigned to the one or more first spatial streams, and 3 or 4 bits indicative of the total number of the plurality of spatial streams.

9. The AP of claim 7, wherein each user field comprises a plurality of bits, wherein the plurality of bits comprises at least one or more of the following bits: 11 bits encoding an identifier of the respective first non-AP station (119a-b), 4 bits encoding a modulation and coding scheme, 1 bit encoding a coding scheme, 6 bits encoding a spatial configuration, 4 bits encoding an offset value indicative of a smallest index value assigned to the one or more first spatial streams, and 3 or 4 bits indicative of the total number of the plurality of spatial streams.

10. The AP of claim 8, wherein the 4 bits encoding the offset value and the 3 or 4 bits indicative of the total number of the plurality of spatial streams are the 7 or 8 most or least significant bits of the plurality of bits of the user field.

11. The AP of claim 1, wherein the frame comprises one or more EHT SIG common fields and wherein each EHT SIG common field comprises at least a portion of the management information.

12. The AP of claim 11, wherein each EHT SIG common field comprises a plurality of bits, wherein the plurality of bits comprises at least one or more of the following bits: 4 bits encoding an offset value indicative of a smallest index value assigned to the one or more first spatial streams, 2 bits encoding a guard interval and EHT training field size, 3 bits encoding a number of EHT training field symbols, 1 bit encoding a LDPC extra symbol segment, 2 bits encoding a pre-FEC padding factor, 1 bit encoding a PE disambiguity, 3 bits encoding a number of non-OFDMA user and/or 3 or 4 bits indicative of the total number of the plurality of spatial streams.

13. The AP of claim 12, wherein the 4 bits encoding the offset value are the 4 most or least significant bits of the EHT SIG common field and wherein the 3 or 4 bits indicative of the total number of the plurality of spatial streams are the 3 or 4 least or most significant bits of the EHT SIG common field.

14. The AP of claim 11, wherein each EHT SIG common field comprises a plurality of bits, wherein the plurality of bits comprises at least one or more of the following bits: 4 bits encoding a Spatial Reuse configuration, 2 bits encoding a guard interval and EHT training field size, 3 bits encoding a number of EHT training field symbols, 1 bit encoding a LDPC extra symbol segment, 2 bits encoding a pre-FEC padding factor, 1 bit encoding a PE disambiguity, 3 bits encoding a number of non-OFDMA user, 4 bits encoding an offset value indicative of a smallest index value assigned to the one or more first spatial streams and/or 3 or 4 bits indicative of the total number of the plurality of spatial streams.

15. The AP of claim 14, wherein the 4 bits encoding the offset value and the 3 or 4 bits indicative of the total number of the plurality of spatial streams (141-147) are the 7 or 8 most or least significant bits of the plurality of bits of the EHT SIG common field (211).

16. The AP of claim 1, wherein the frame comprises a U-SIG field and wherein the U-SIG field comprises at least a portion of the management information.

17. The AP of claim 16, wherein the U-SIG field comprises a plurality of bits defining a U-SIG-1 portion and a U-SIG-2 portion and wherein at least the portion of the management information is encoded in bits 20-24 and/or bit 25 of the U-SIG-1 portion and/or in bit 2 and/or bit 8 of the U-SIG-2 portion.

18. The AP of claim 16, wherein the U-SIG field comprises a plurality of bits defining a U-SIG-1 portion and a U-SIG-2 portion, wherein bits 20-24 and/or bit 25 of the U-SIG-1 portion encode a spatial configuration and at least a portion of the management information is encoded in bit 2 and/or bit 8 of the U-SIG-2 portion.

19. The AP of claim 16, wherein the U-SIG field comprises a plurality of bits, wherein the plurality of bits comprises at least one or more of the following bits: 3 bits encoding a physical layer version identifier, 3 bits encoding a bandwidth, 1 bit encoding an uplink or downlink direction, 6 bits encoding a BSS color, 7 bits encoding a transmission opportunity, 4 bits encoding an offset value indicative of a smallest index value assigned to the one or more first spatial streams, and/or 3 or 4 bits indicative of the total number of the plurality of spatial streams.

20. The AP of claim 19, wherein the 4 bits encoding the offset value and the 3 or 4 bits indicative of the total number of the plurality of spatial streams are the 7 or 8 most or least significant bits of the plurality of bits of the U-SIG field.
